(19) United States
(12) Patent Application Publication
(10) Pub. No.: US 2025/0012312 A1
(43) Pub. Date: Jan. 9, 2025

(54) SCREW

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); CHEN-LONG SU, KAOHSIUNG CITY (TW)

(21) Appl. No.: 18/346,982

(22) Filed: Jul. 5, 2023

(51) Int. Cl. F16B 25/00

(52) U.S. Cl. CPC F16B 25/0052

(57) ABSTRACT

A screw includes a shank defining exposed surface sections between spaced-apart thread convolutions, a head and a drill portion disposed at opposite ends of the shank, and at least one knurl portion having troughs recessedly crossing each other within at least one surface section. Each thread convolution has a thread crest formed along a junction of two thread flanks, notches cut into the thread crest, cutting units each situated between every two adjacent notches, and cutting edges each formed around an outer periphery of each notch. Each cutting unit of one thread convolution is aligned with each corresponding notch of another adjacent thread convolution. The cutting units and the cutting edges facilitate a quick cutting effect. Chips are allowed to travel in the notches and the troughs, thereby attaining a quick removal of chips, achieving a suitable accumulation of chips for a tight engagement, and attaining an anti-loosening effect.

### BACKGROUND OF THE INVENTION

### 1. Field of the Invention

This invention relates to a screw and relates particularly to a screw capable of enlarging spaces for accommodating and moving chips, improving cutting effect, and avoiding cracking of a workpiece.

### 2. Description of the Related Art

Referring to FIGS. 1 and 2, a conventional screw 1 comprises a shank 11 having a first end and a second end opposite to the first end, a head 12 disposed at the first end of the shank 11, a drill portion 13 disposed at the second end of the shank 11, and a plurality of thread convolutions 14 spirally disposed on the shank 11. Each thread convolution 14 has an upper thread flank 141 extending outwards from the shank 11 and facing the head 12, a lower thread flank 142 extending outwards from the shank 11 and facing the drill portion 13, and a thread crest 143 formed along a junction of the upper thread flank 141 and the lower thread flank 142. During a screwing operation, the drill portion 13 is situated at a surface of a workpiece 2. A rotational force is applied on the head 12 to carry out a cutting operation of the drill portion 13 and the thread convolutions 14 into the workpiece 2. After the screw 1 is embedded in the workpiece 2, the screwing operation is completed.

However, the thread convolutions 14 bear larger screwing resistance during the screwing operation because the thread convolutions 14 are formed to have complete threads. In other words, the thread convolutions 14 are provided without any notch, and that increases a contact area between the thread convolutions 14 and the workpiece 2. Thus, the screwing resistance will increase when the thread convolutions 14 cut the workpiece 2, and that may wear and damage the thread convolutions 14. The worn and damaged thread convolutions 14 cannot sever fibers of the workpiece 2 effectively. Spaces defined between the thread convolutions 14 and the shank 11 are not enough for chips exclusion and accommodation. Therefore, the chips are discharged slowly, and that will increase the screwing resistance and reduce the screwing speed. If the screw 1 keeps pressing the chips, the workpiece 2 may crack. Further, the screw 1 cannot hold the chips sufficiently, and that will result in poor engagement between the screw 1 and the workpiece 2. The screw 1 may be loose and fall from the workpiece 2 easily, and that requires to be improved.

### SUMMARY OF THE INVENTION

The object of this invention is to provide a screw capable of severing fibers of a workpiece, enhancing cutting effect, providing enough spaces for chips to thereby reduce screwing resistance and attain a tight engagement.

The screw of this invention comprises a shank having opposite first and second ends, a head formed at the first and, a drill portion formed at the second end, and a plurality of thread convolutions spiraled on the shank and axially spaced apart so as to define a shank surface exposed to an outside of the shank. The shank surface is divided into a plurality of surface sections defined between adjacent thread convolutions, with at least one knurl portion arranged on at least one surface section. The knurl portion has a plurality of troughs crossing each and formed recessedly. Each thread convolution has an upper thread flank and a lower thread flank facing opposite directions, a thread crest formed along a junction of the upper thread flank and the lower thread flank, a plurality of notches recessed into the thread crest, a plurality of cutting edges each formed along an outer periphery of a corresponding one notch respectively, and a plurality of cutting units. Every two adjacent cutting units are separated by one notch so that the cutting units and the notches are arranged in an alternating manner. Each cutting unit of one thread convolution is aligned with a corresponding one notch of another thread convolution adjacent to the one thread convolution. During a screwing operation, the cutting units and the cutting edges are adapted to cut fibers of a workpiece into chips effectively to thereby improve the cutting effect. The chips are allowed to pass through the notches, and simultaneously move outwards quickly through the troughs. Further, the remaining chips are accommodated within the notches and the troughs after the screwing operation is complete to thereby reduce the screwing resistance, accelerate the screwing operation, prevent the workpiece from cracking, and allow the screw to engage with the workpiece firmly.

Preferably, the notches are curved in shape.

Preferably, the notches and the cutting units are formed on part of the thread convolutions.

Preferably, a plurality of knurl portions are arranged on the surface sections defined between successive adjacent ones of the thread convolutions.

Preferably, the knurl portion is arranged on a corresponding one of the surface sections between every other thread convolution so that a plurality of knurl portions are spaced apart from each other.

Preferably, at least one surface section is recessedly formed to define an annular groove.

Preferably, the knurl portion occupies a partial surface of the surface section.

Preferably, the thread convolutions define a first threaded portion and a second threaded portion. The second threaded portion is spirally disposed on the shank and between the first threaded portion.

### BRIEF DESCRIPTION OF THE DRAWINGS

FIG. 1 is a schematic view showing a conventional screw;

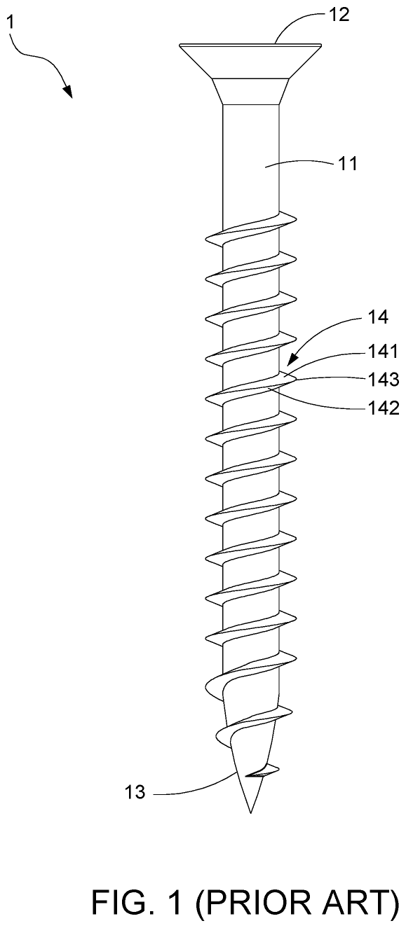

FIG. 2 is a schematic view showing a screwing operation of the conventional screw;

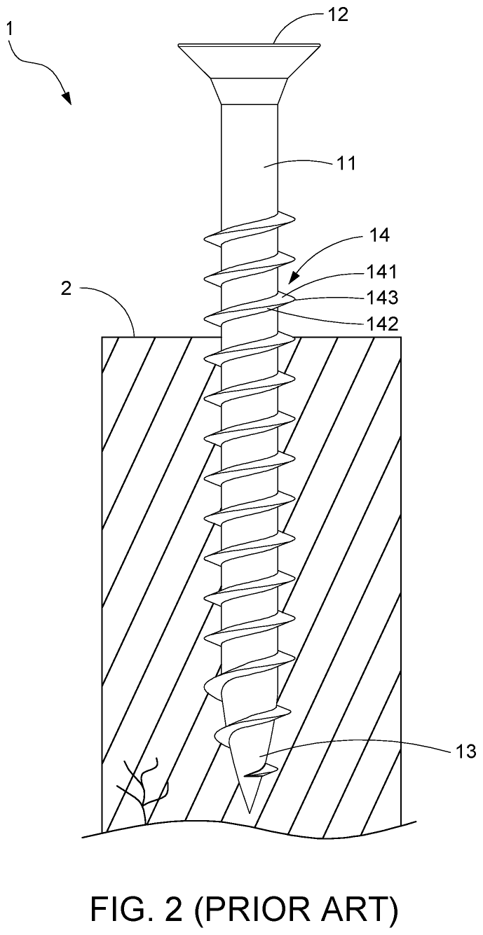

FIG. 3 is a schematic view showing a first preferred embodiment of this invention;

FIG. 4 is an enlarged view of the encircled portion X indicated in FIG. 3;

FIG. 5 is a cross-sectional view showing the thread convolutions as seen along the line A-A of FIG. 3;

FIG. 6 is a schematic view showing a screwing operation of the first preferred embodiment of this invention;

FIG. 7 is a schematic view showing a second preferred embodiment of this invention characterized by a plurality of knurl portions spaced apart from each other;

FIG. 8 is a schematic view showing a third preferred embodiment of this invention characterized in that the knurl portions and the annular grooves are arranged in an alternating manner, with a first threaded portion and a second threaded portion formed on the shank;

FIG. 9 is a schematic view showing the first threaded portion and the second threaded portion; and

FIG. 10 is a schematic view showing a fourth preferred embodiment of this invention characterized in that the knurl portion occupies a partial surface of the surface section.

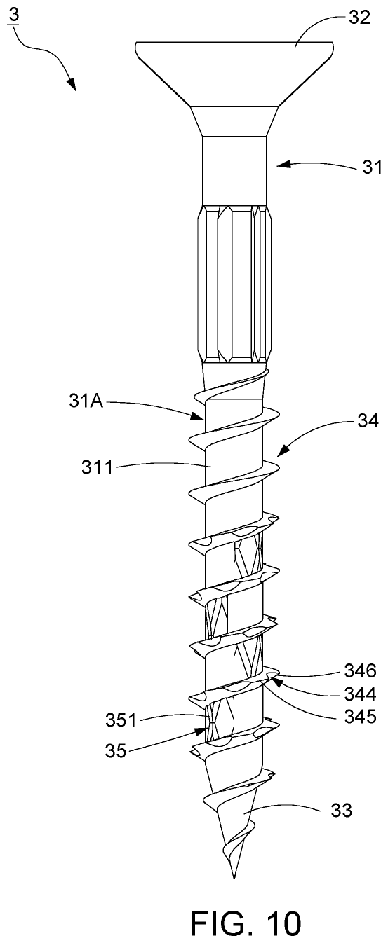

### DETAILED DESCRIPTION OF THE PREFERRED EMBODIMENTS

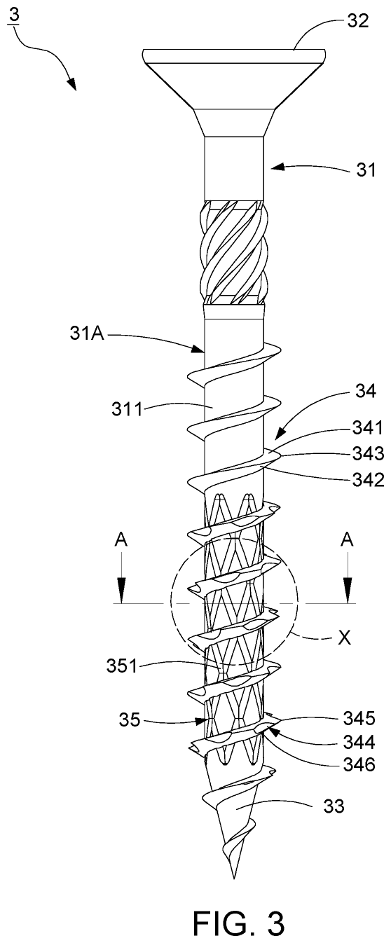

Referring to FIG. 3, a first preferred embodiment of a screw 3 of this invention is disclosed. The screw 3 includes a shank 31 having a first end and a second end opposite to the first end, a head 32 formed at the first end the shank 31, a drill portion 33 formed at the second end of the shank 31, and a plurality of thread convolutions 34 spirally formed on the shank 31. The thread convolutions 34 extend and spaced apart from each other in an axial direction to define a shank surface 31A exposed to an outside of the shank 31. The shank surface 31A is divided into a plurality of surface sections 311 each defined between every two adjacent thread convolutions 34. At least one knurl portion 35 is recessedly formed in at least one surface section 311. The knurl portion 35 has a plurality of troughs 351 crossing each other and recessedly formed in the surface section 311. In this preferred embodiment, a plurality of knurl portions 35 are arranged on the surface sections 311 defined between seven successive adjacent ones of the thread convolutions 34.

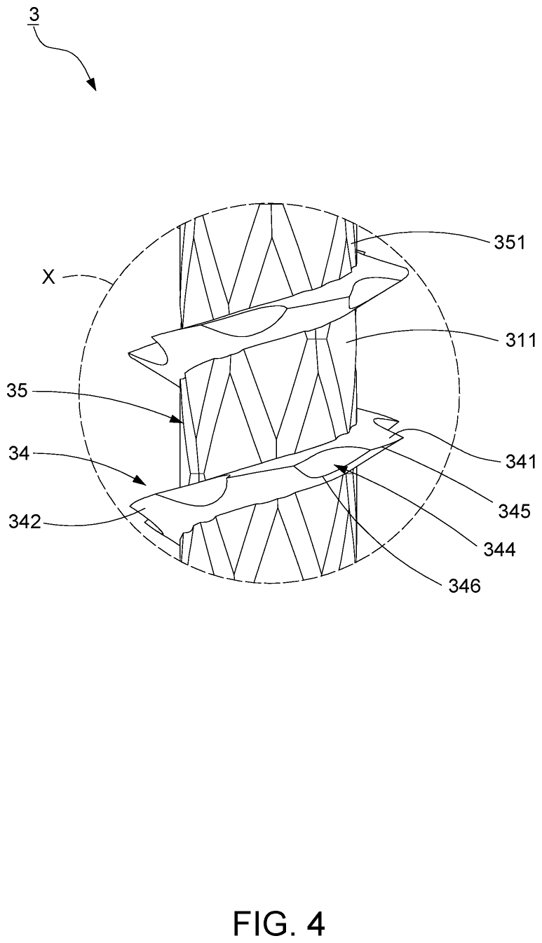

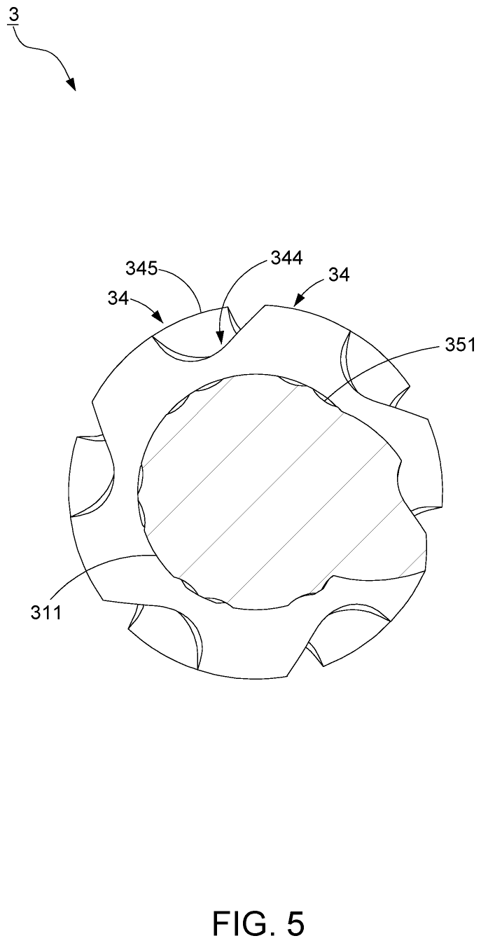

Referring to FIGS. 3 and 4, each thread convolution 34 has an upper thread flank 341 extending outwards from the shank 31 and facing the head 32, a lower thread flank 342 extending outwards from the shank 31 and facing the drill portion 33, a thread crest 343 formed along a junction of the upper thread flank 341 and the lower thread flank 342, a plurality of notches 344 recessed in the thread crest 343, a plurality of cutting units 345 each situated between every two adjacent notches 344, and a plurality of cutting edges 346 each formed along an outer periphery of each corresponding one notch 344. In this preferred embodiment, the notches 344 are spaced apart from each other. Every two adjacent cutting units 345 are separated by one notch 344 so that the cutting units 345 and the notches 344 are arranged in an alternating manner. Referring to FIG. 5, each cutting unit 345 of one thread convolution 34 is situated in alignment with a corresponding one notch 344 of another thread convolution 34 adjacent to the one thread convolution 34. In other words, the cutting units 345 of every two adjacent thread convolutions 34 are staggered. Thus, the positions of the notches 344 and the cutting units 345 of one thread convolutions 34 are arranged opposite to the positions of the notches 344 and the cutting units 345 of another adjacent thread convolution 34. In this preferred embodiment, the notches 344 and the cutting edges 346 are formed in a curved shape. The notches 344, the cutting edges 346, and the cutting units 345 are formed on five and six thread convolutions 34.

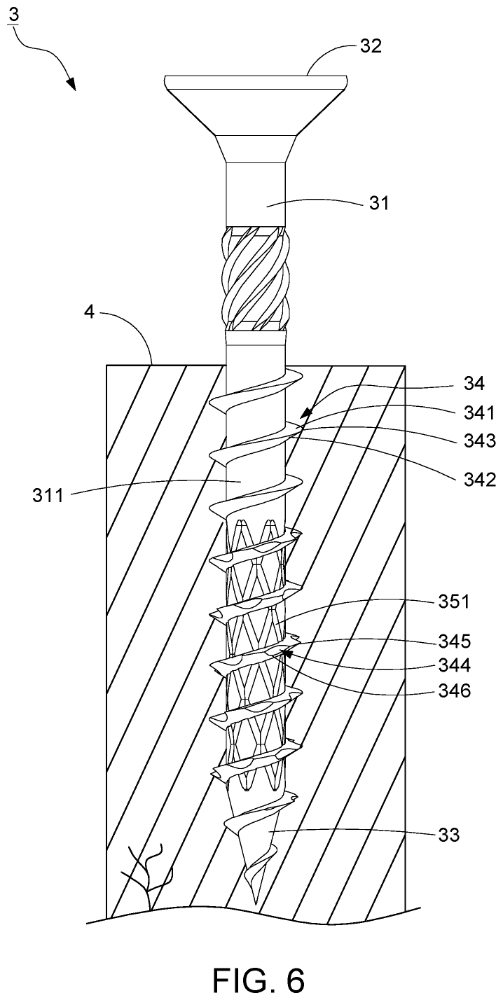

Referring to FIGS. 3, 4 and 6, during a screwing operation of the screw 3, the drill portion 33 is positioned against a surface of a workpiece 4. Then, the head 32 receives a rotational force in order to carry out a cutting operation of the drill portion 33 and the thread convolutions 34. During the cutting operation, the notches 344 formed on the thread convolutions 34 help reduce a contact area between the thread convolutions 34 and the workpiece 4 to thereby lower the screwing resistance caused when the thread convolutions 34 cut into the workpiece 4. Meanwhile, the cutting units 345 and the cutting edges 346 sever fibers of the workpiece 4 into chips effectively to thereby prevent the shank 31 from being entangled in twisting fibers, reduce the screwing resistance, and improve the cutting effect. Because the cutting units 345 of each thread convolution 34 is aligned with the corresponding notches 344 of another adjacent thread convolution 34 to thereby attain the multiple cutting effect and cut the fibers of the workpiece 4 completely. Further, the troughs 351 enlarge spaces for accommodating and discharging the chips, and the chips are allowed to move smoothly and speedily in the troughs 351 and the notches 344 and are discharged outwards accordingly. Thus, the screw 3 can screw into the workpiece 4 quickly without be hindered by the chips. The screwing speed is increased and the screwing operation is accelerated. The chips will not accumulate unduly, and that prevents the workpiece 4 from cracking. After the screw 3 is embedded in the workpiece 4, the remainder of chips are received within the troughs 351 and the notches 344 duly to thereby attain a tight engagement between the screw 3 and the workpiece 4, prevent the screw 3 from being loose or falling, and achieve preferable anti-loosening effect.

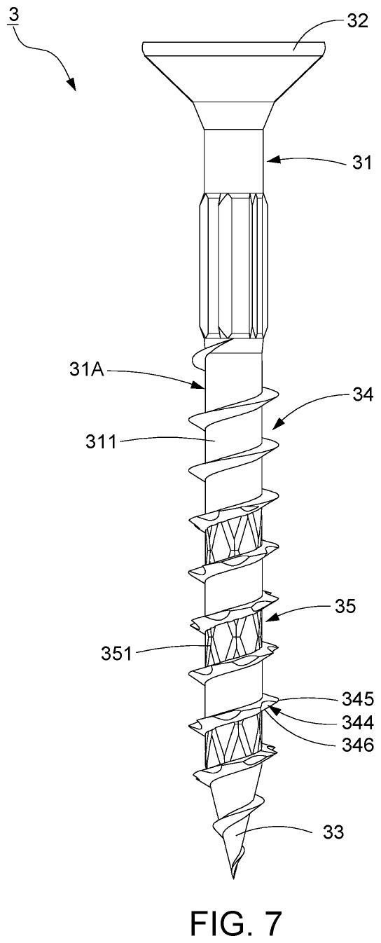

Referring to FIG. 7 shows a second preferred embodiment of the screw 3 of this invention. The correlated elements and the concatenation of elements, the operation and objectives of the second preferred embodiment are the same as those of the first preferred embodiment. This embodiment is characterized in that the knurl portion 35 is arranged on a corresponding one of the surface sections 311 between every other thread convolution 34 so that a plurality of knurl portions 35 are spaced apart from each other. Namely, when one knurl portion 35 is arranged on one surface section 311, another surface section 311 adjacent to the one surface section 311 is flat in shape so that the flat surface sections 311 and the surface sections 311 provided with the knurl portion 35 are arranged in an alternating manner.

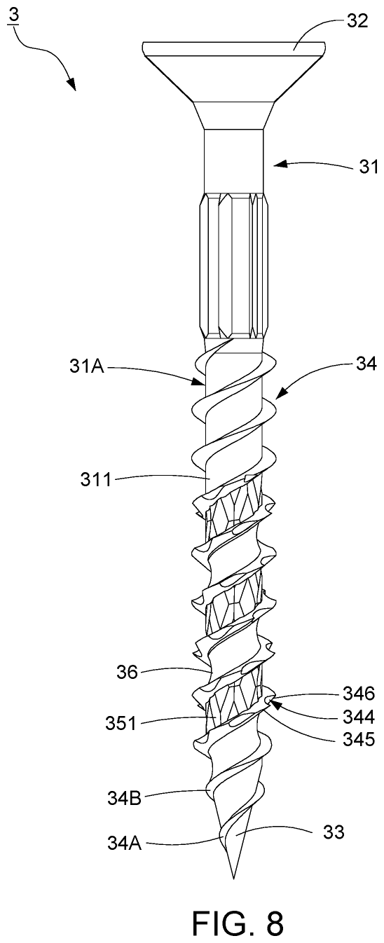

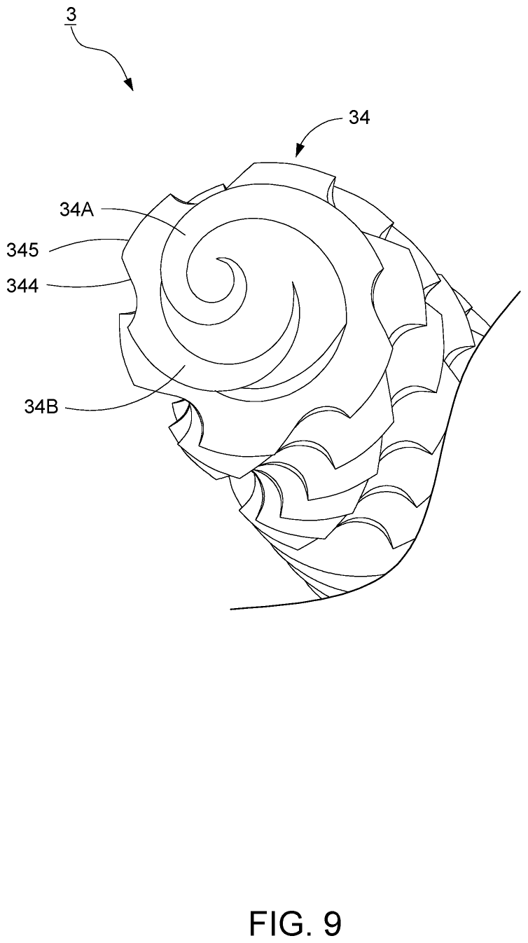

Referring to FIGS. 8 and 9 shows a third preferred embodiment of the screw 3 of this invention. The correlated elements and the concatenation of elements, the operation and objectives of the third preferred embodiment are the same as those of the first preferred embodiment. This embodiment is characterized in that part of the surface sections 311 are each recessedly formed to define an annular groove 36, and the knurl portions 35 are arranged on the remainder of the surface sections 311. Preferably, the annular grooves 36 and the knurl portions 35 are arranged on the surface sections 311 respectively in an alternating manner. The thread convolutions 34 define a first threaded portion 34A and a second threaded portion 34B. The second threaded portion 34B is spirally formed on the shank 31 and between the first threaded portion 34A.

Referring to FIG. 9 shows a fourth preferred embodiment of the screw 3 of this invention. The correlated elements and the concatenation of elements, the operation and objectives of the fourth preferred embodiment are the same as those of the first preferred embodiment. This embodiment is characterized in that each knurl portion 35 occupies a partial surface of each surface section 311. In other words, only the partial surface of the surface section 311 is provided with the knurl portion 35. The remaining surface of the surface section 311 is flat in shape.

To sum up, the screw of this invention takes an advantage that the notches cut into the thread convolutions, with the cutting edges formed along the outer periphery of the notches, and the cutting units are each situated between every two adjacent notches whereby the thread convolutions bear smaller screwing resistance and sever the fibers of the workpiece effectively. The notches and the troughs allow the chips to travel therein, and provide enough spaces for the chips to thereby quickly exclude the chips outwards, reduce the screwing resistance, increase the screwing speed, and prevent the workpiece from cracking. Meanwhile, sufficient chips are accommodated within the troughs and the notches after the screw is embedded in the workpiece whereby the screw engages with the workpiece tightly, and that prevents the screw from being loose or falling from the workpiece easily.

While the embodiments of this invention are shown and described, it is understood that further variations and modifications may be made without departing from the scope of this invention.

What is claimed is:

1. A screw comprising a shank having opposite first and second ends, a head disposed at said first end, a drill portion disposed at said second end, and a plurality of thread convolutions spirally formed between said first end and said second end of said shank, each of said plurality of thread convolutions having an upper thread flank facing said head, a lower thread flank facing said drill portion, and a thread crest formed along a junction of said upper thread flank and said lower thread flank;
wherein adjacent thread convolutions are axially spaced apart so that said shank defines a shank surface exposed to an outside, with said shank surface divided into a plurality of surface sections defined between said adjacent thread convolutions, said shank surface including at least one knurl portion formed on at least one surface section, said at least one knurl portion having a plurality of recessedly-formed troughs crossing each other, a plurality of notches being cut into said thread crests of said plurality of thread convolutions, with a cutting edge formed along an outer periphery of each said notch, a plurality of cutting units being each formed between every two adjacent notches, each said cutting unit of one thread convolution being situated in alignment with a corresponding one notch of another thread convolution adjacent to said one thread convolution.

2. The screw according to claim 1, wherein said plurality of notches are curved in shape.

3. The screw according to claim 1, wherein said plurality of notches and said plurality of cutting units are formed on part of said thread convolutions.

4. The screw according to claim 1, wherein a plurality of knurl portions are arranged on said plurality of surface sections defined between successive adjacent ones of said thread convolutions.

5. The screw according to claim 1, wherein said at least one knurl portion is arranged on a corresponding one of said surface sections between every other thread convolution so that a plurality of knurl portions are spaced apart from each other.

6. The screw according to claim 1, wherein at least one of said surface sections is recessedly formed to define an annular groove.

7. The screw according to claim 1, wherein said at least one knurl portion occupies a partial surface of said at least one surface section.

8. The screw according to claim 1, wherein said plurality of thread convolutions define a first threaded portion and a second threaded portion, with said second threaded portion spirally disposed on said shank and between said first threaded portion.
